(19) United States
(12) Patent Application Publication
(10) Pub. No.: US 2007/0038586 A1
(43) Pub. Date: Feb. 15, 2007

(54) Data processing method based on simple element dynamic structures

(75) Inventor: Xavier Vaucois, Chatillon (FR)

Correspondence Address: LERNER, DAVID, LITTENBERG,;KRUMHOLZ & MENTLIK, 600 SOUTH AVENUE WEST, WESTFIELD, NJ, 07090, US

(73) Assignee: KANKOON, Paris (FR)

(21) Appl. No.: 10/571,186

(22) PCT Filed: Sep. 9, 2004
(86) PCT No.: PCT/FR04/02288

§ 371 Date: Mar. 9, 2006

(30) Foreign Application Priority Data
Sep. 12, 2003 (FR) 0310737

(51) Int. Cl. G06F 15/18

(52) U.S. Cl. 706/14

(57) ABSTRACT

A method is provided for processing information which includes storing in a memory of an information processing system (i) a plurality of individually identified information-bearing entities (“IBEs”), and (ii) a dictionary including a plurality of simple elements, each simple element having a meaning. A plurality of dynamic structures are stored in the memory, each dynamic structure being stored in association with at least one stored IBE, wherein each dynamic structure includes (i) at least one knowledge object including a plurality of simple elements selected from the stored dictionary, (ii) first information identifying the selected simple elements in the at least one knowledge object and (ii) second information identifying links between the selected simple elements. At least ones of the stored IBEs are processed with a processor of an information processing system, using the first and second information contained in the stored dynamic structures associated with the ones of the IBEs.

The present invention generally relates to information systems, and more particularly to a new method for managing and processing information, notably for managing skills and knowledge.

### BACKGROUND OF THE INVENTION

Presently, information systems based on a plurality of information-bearing entities (EPIs hereafter)—such as documents containing knowledge, portfolios of skills of individuals, etc.—, model and handle each EPI through repositories, indexes, definitions, categories and rules made by communities of experts. Thus the repositories, indexes, definitions, categories and rules are the mandatory transition point of all the present technologies in order to organize, categorize and compare such EPIs with each other.

The present systems therefore require a lot of time and personnel in order to be applied because the repositories, indexes, definitions, categories and rules are highly complex to define. Thus, the latter should continually be changed in order to take into account the meaning of the information which they process. The users are required to have very good knowledge, therefore only a reduced number of experts may use them qualitatively. Further, they may only manage the initially provided EPIs during the design and application of the system. Finally, they do not take into account the different contexts in which the information is processed.

Consequently, many problems are posed when:
the system must process a significant volume of heterogeneous information and be set up rapidly;
the system should also continuously take into account the rapid development of the meaning of the information;
the system should be used at a large scale by different and various communities of persons having different levels of interpretation of the information;
the system should manage a high level of qualification of the information contained in the EPIs regardless of the number and diversity of the EPIs and of the number and diversity of persons interacting with the system;
the system should allow, without being modified, adding of new EPIs of types different from the existing EPIs;
the system should take into account the context of the information.

The present information systems based on repositories, indexes, definitions, categories and rules for the majority of them are statistic, probabilistic, linguistic analysis systems, full text, semantic or artificial intelligence indexation systems, categorization systems and mapping systems.

These systems and methods were developed by companies such as Google™, Inktomi™, Altavista™, Fast™, Overture™, Intelliseek™, Jeeves Solutions™, Nothem Light™, Excite™, Hotbot™, Voila™, Dataware™, Meta4™, Lycos™, Verity™, Convera™, Autonomy™, Hummingbird™, Opentext™, IBM™, Microsoft™, SAP™, Oracle™, SUN™, Semio™, Inxight™, Clearforest™, Easyask™, Iphrase™, Primus™, Semantic Edge™, Albert™, Inquizit™, XYZfind™, Dtsearch™, Exalead™, Askme™, Sinequa™, Triplehop™, Xyleme™, Arisem™, Dimension5™, Grimmersoft™, Kartoo™, Mapstan™, Plumb design™, Semiosys™, Sensoria Technologies™, Datops™, Inforama™, IRIT™, Lexiquest™, CISI™, Copernic™, Lotus™ and Trivium™.

As for managing knowledge, several systems are found in the state of the art:
so-called statistic systems, which answer a request according to the frequency of occurrence of requested criteria and to their repetition within each document;
linguistic analysis systems, which provide a first answer to the problem of natural language requests; they are based on linguistic analysis functions and interpret the request in languages specific to searching tools;
so-called semantic systems, which attempt to integrate the meaning of the language into the categorization and search process; for this purpose, they rely on repositories, or even specialized thesauruses for processing particular sets of themes;
finally so-called multi-dimensional systems, which are inspired by techniques from decision analysis systems to refine categorization of documents, as well systems based on crossed requests.

But all the known information systems have a number of drawbacks, which will be detailed below.

The first problem which is posed concerns their application: present systems are complex, unwieldy and long to be applied. As stated, they are based on repositories, indexes, definitions, categories, and rules, established at a given time by a community of experts who should meet in order to build, modify, administrate and use them. These repositories, indexes, definitions, categories and rules are used for ordering and retrieving EPIs according to unique and constant criteria.

Now, experts rarely agree on repositories, indexes, definitions, categories and rules because every one of them interprets the information contained in the EPIs in their own way, because each community has a use of the system specific to their universe and this imposes constraints on the contents of the repositories, indexes, definitions, categories and rules, because the information is heterogeneous and finally because the amount of information is large and continues to increase and develop rapidly. By definition, the systems should be suitable for a large number of experts coming from different universes. The systems are therefore complex, unwieldy and long to set up and are not suitable for all the members of the communities.

The second problem which is posed concerns the development of information systems over time. Present systems are static and discrete. As time passes, the meaning of the information changes. The number of EPIs increases in parallel. Development is increasingly fast. Systems are thus practically obsolete as soon as they are set up. They have to be redone, i.e., again change the repositories, indexes, definitions, categories and rules. Thus, their update makes use of repeating discrete processes on the one hand and repeating periodical processes on the other hand, both achieved by experts. These processes themselves are also complex, unwieldy and long to be applied. After updating these repositories, indexes, definitions, categories and rules, the EPIs classified earlier also need to be reclassified and the new unclassified EPIs need to be put away. Further, the first problem is also posed again whenever the meaning of the information changes.

The third problem which is posed concerns the understanding and the use of repositories, indexes, definitions, categories and rules by the different and varied communities having different levels of interpretation of the information. Thus, the present information processing systems are generally <<closed>>: they are produced by a community of experts for this same community. To maximize the use of information systems, it is absolutely necessary that the latter be well understood by the users. Presently, only communities of persons having an interpretation level close to that of experts are able to utilize the repositories, indexes, definitions, categories and rules with the meaning which was given to them initially. As unique and permanent ordering criteria are very difficult to find and depend on the person who uses the system, generally, at a large scale, the ordering attempt finally generates confusion. Now, in order to process all the EPIs from a unique point, the systems are however deployed at a large scale and they are increasingly open to communities external to those of the experts. The amount of heterogeneous information explodes. The repositories are less and less significative relatively to these external communities, and especially their contents often mean something different depending on the communities. The systems therefore do not fulfill satisfactorily the role which one seeks to give them.

The fourth problem which is posed, concerns maintaining or increasing the quality level of the system while extending it to several communities and/or by increasing the number of managed EPIs. Present information processing systems are centralized and administrative. They are not provided for being interactive, i.e., so that all the communities interact with each other and participate in their proper operation. A community defines its repositories, indexes, definitions, categories and rules according to the common meaning of information in this community. If the number of communities interacting with the system increases and/or if the number of managed EPIs increases, i.e., if the system becomes distributed and operational, then it is necessary either to reduce the fineness level of the repositories, indexes, definitions, categories and rules in order to make the system understandable (with the risk of having a very general system and different EPIs classified in identical categories), or increase the number of repositories, indexes, definitions, categories and rules to make the system accurate with the risk of having a too complicated system and similar EPIs classified in different categories. Anyhow, in any case, the global quality of the system decreases when it becomes distributed and operational.

This last problem is encountered when people belonging to different communities in terms of interpretation of information are led to interact with the system as this is increasingly the case in the system for managing skills and in the management of skills. The present systems reveal the uncertainty relating the fineness level describing the information and the width of the interpretation spectrum.

A fifth problem which is posed is that of the development of information systems and notably of a development which saves what exists and which does not interrupt operation of the systems. Present information systems are finite. When they are designed, they are provided in order to manage a finite number of EPIs of predefined types, such as documents for systems for managing knowledge, the skills of individuals in skill management systems, etc, and a finite number of communities of a predefined type such as the human resource management community in an organization. In the initial state, with the system, operations may be carried out between EPIs of a predefined type for a given community. When new EPIs are managed (such as for example training courses) and/or when opening up to a new community of users, it becomes impossible to carry out operations between the initial EPIs and the new ones without having to fully replace the system after having entirely reconsidered it beforehand.

Finally a sixth problem which is posed concerns contextualization of information in the system. Presently, the systems establish lists of non-contextualized information for each EPI. This information is not related to contexts in which they are relevant. Consequently, the information lacks relevance.

### SUMMARY OF THE INVENTION

The invention is aimed at overcoming these drawbacks of the state of the art and proposing a method capable of being applied in an information system, which is based on representing any piece of information by dynamic structures of <<knowledge objects>>, themselves based on a common dictionary of simple elements with multiple eigen characteristics.

More specifically, the present invention aims at proposing a method for processing information, providing new modeling of the data and a new handling technique which allows each user whatever his/her universe, to model and handle any structured, semi-structured and non-structured EPI—as a document containing knowledge, the portfolio of skills of an individual, etc.—without having to build, apply, update and utilize beforehand repositories, indexes, definitions, categories and rules, without having to rebuild the system as soon as the meaning of the processed information changes, without having to rebuild the system as soon as new EPIs need to be managed, and without compelling all the users to perfectly master the system, and this by contextualizing information.

The invention thus proposes a method for processing data in a computer environment comprising processing means and a memory, characterized in that it comprises the following steps:
providing in the memory a plurality of individually identified information-bearing entities,
providing in the memory a dictionary of irreducible simple elements capable of characterizing the information-bearing entities,
providing in the memory, in association with each information-bearing entity, a dynamic structure comprising at least one knowledge object consisting of simple elements selected from the dictionary of simple elements, the stored dynamic structure comprising first information identifying the respective simple elements and second information identifying links between simple elements in the knowledge objects, the number of knowledge objects and the number of simple elements in the knowledge objects being able to vary from one dynamic structure to the other, and the dynamic structure being able to vary over time according the behaviour of the users and to calculations performed by the processing means,
performing processing operations on information-bearing entities by using the first and second information of their current associated dynamic structures.

Certain preferred, but non-limiting, aspects of this method are the following:
each simple element may be present in several knowledge objects of the stored dynamic structure.
each stored dynamic structure comprises, in association with each simple element, at least one attribute of the simple element in its knowledge object and the processing step also uses at least certain attributes of the simple elements.
the attributes of simple elements in dynamic structures have values selected from the values set by the user, from values calculated according to other information from the dynamic structure containing the relevant simple element, and from values calculated according to the number of occurrences of the relevant simple element in all or a determined part of the dynamic structures containing these different simple elements.
each stored dynamic structure also comprises, in association with each knowledge object, at least one of attribute of the knowledge object, and the processing step also uses at least certain attributes of knowledge objects.
at least one knowledge object attribute value is calculated from values of attributes of corresponding simple elements contained in the knowledge object.
at least one knowledge object attribute value is set by an operator building the knowledge object.
the method comprises an initial step for creating starting dynamic structures and repeated steps for changing the dynamic structures by authorized users.
the dictionary of simple elements comprises in the memory, at least one base in which the simple elements are organized into a plurality of groups of simple elements, themselves organized into a plurality of dimensions, and a step is provided for displaying simple elements, for selection, in a visual organization corresponding to the layout of the dimensions and of the groups of the base.
each group is represented in memory as a simple element selectable in the same way as other simple elements.
the dictionary of simple elements comprises in the memory at least two bases in which the same simple elements are organized in different groups and/or dimensions, and the display step comprises a selective display according to one of several visual organizations corresponding to the layouts of the different bases.
the method further comprises the steps:
   providing in the memory, a table of users containing, in association with identifiers of respective users, membership attributes of said users, and
   according to the value of the membership attribute of a user, applying the display step according to a visual organization corresponding to the layout of a base as designated by the membership attribute of said user, or if necessary, of only a portion of a database as designated by the membership attribute of said user.
The layout of a base is a tree layout, and in that the layout of only a portion of a base consists of a limited number of tree levels in the layout.
the processing step comprises the comparison of dynamic structures of at least two information-bearing entities.
the processing step comprises the comparison of dynamic structures of a plurality of information-bearing entities with the dynamic structure(s) of one or more reference information-bearing entities, making up a request.
the comparison step brings into play a mathematical and/or logical combination of the presence/absence of simple elements in the dynamic structures, the presence/absence of simple elements together in the knowledge objects of the dynamic structures, and values of the attributes of the simple elements and knowledge objects.

### SHORT DESCRIPTION OF THE DRAWINGS

Other objects, features and advantages of the present invention will become clearly apparent upon reading the following detailed description, given as a non-limiting example and made with reference to the appended drawings, wherein:

FIG. 1 represents a system for processing information from the state of the art, and more specifically the one marketed by Hummingbird™.

FIG. 2 represents a dictionary structure with an example of dimensions, groups and simple elements (ES hereafter).

FIG. 3 represents an EPI of the <<dynamic skill portfolio type>> of an individual and its dynamic structure of a knowledge object (OC hereafter).

FIG. 4 represents a particular OC of an OC dynamic structure corresponding to a skill.

FIG. 5 represents a document or input mask attached to an OC corresponding to a simulation.

FIG. 6 represents EPIs of the <<job profile>> type and their OC dynamic structure.

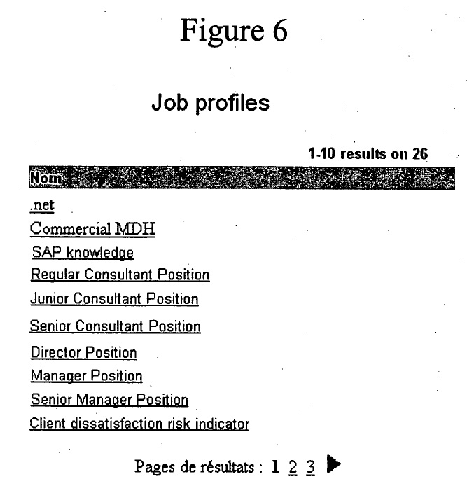

FIG. 7 represents a dynamic structure of generic knowledge objects

FIG. 8 represents two simulations attached to a OC.

### DETAILED DESCRIPTION OF A PREFERRED EMBODIMENT

Preamble

In the present exemplary embodiment, the invention is applied in a computer environment used for managing skills and knowledge in a company. The present invention is preferably used from a computer environment equipped with an Internet browser such as Internet Explorer (trademark of Microsoft Corp.). The invention may also be applied in the Web client mode and the Web service mode.

A Web client system is a resource which may access the Web by means of a network interface which sends requests and receives answers to these requests. A Web service is a resource accessible on the Web by means of a network interface which accepts requests and sends back answers to these requests. This resource is formally described by a software interface contained in a service description document. The technology of Web services is recent and the state of the art is for example described in WO 00 68828 A.

It will be recalled here that the principle of present information processing systems consists of incorporating or <<placing>> information-bearing entities (EPIs hereafter) in repositories, indexes, definitions, categories and rules.

Conversely, the principle of the invention consists of establishing a set of simple elements (hereafter <<ESes>>) determined from repositories, indexes, definitions, categories and rules, and of incorporating ESes selected from this set into the EPIs. With the invention, the information containing in each EPI may be modeled and handled by means of dynamic structures of knowledge objects (<<OCs>> hereafter) and by means of operations between these structures. The invention therefore radically changes the operating principle of information processing systems.

### 1) Glossary

The following part is a glossary of the terms used in the present specification.

Simple Element:

An element or ES is a piece of information stored in a memory of a computer system and defined by a set of eigen characteristics, comprising in the case in point:
a name (a string of characters).
a symbol or icon (bitmap image).
a pointer: ESes are managed by pointers which provide different eigen characteristics for example according to the selected language. The system may be multilingual in this case.
a description: the description is an explanatory text of the information piece. This description enables the users to know the meaning of ES. A part of the description may provide information allowing the users to evaluate the <<level>> (see this notion later on) of the ES.
the relationships with the other ESes, the groups and dimensions: The relationships between ESes, groups and dimensions are of the <<associated with>>, <<son>>, <<father>>, <<semantic link with>> type.
one or more attributes, in the case in point:
   a <<relative mass>> (MR): MR is a numerical (or even alphabetical) value given to the piece of information in the information processing system.
   a <<relative administrative strategic position>> (PSAR), or <<level>>: PSAR is a numerical (or even alphabetical) value, with which the strategic aspect of the ES may be evaluated in the organization when the administrators use the system.
   a <<relative operational strategic position>> (PSOR): PSOR is a quantity of the numerical (or even alphabetical) type, of the same type as PSAR. PSOR is the result of a function of the system which assumes as a parameter, i.a., the number of occurrences of the ES in all the OC dynamic structures presented in the system. PSOR sends back a result of the <<y level>> type. With this quantity, the strategic aspect of the ES may be evaluated in the organization when all the users use the system.

(the above attributes have the same value for all the occurrences of ES in the different dynamic structures)
a relative imaginary level (NIR): NIR is a numerical (or even alphabetical) quantity with which the relative appreciation of the ES in a OC may be evaluated. Each ES has an NIR when it is not within a OC. In a same OC dynamic structure, an ES may have several NIRs depending on the OCs in which it is found. The NIR of each ES is evaluated by the person responsible for the OC dynamic structure which has the ES. The system takes into account various types of multi-scale evaluations. Certain ESes are evaluated on a scale from 1 to 5, other ones on a scale from 1 to 10, other ones from A to E, etc.
a relative real level (NRR): NRR is a quantity of the numerical (or even alphabetical) type with which the relative appreciation of ES may be evaluated in a OC. Each ES has an NRR when it is within a OC. In a same OC dynamic structure, an ES may have several NRR depending on the OCs in which it is found. The NRR of each ES is evaluated by at least one person other than the person responsible for the OC dynamic structure which has the ES. The system takes into account different types of multi-scale evaluations. Certain ESes are evaluated on a scale from 1 to 5, others on a scale from 1 to 10, others from A to E, etc.
a space-time state: the space state informs on the existence of ES in the different universes (see this notion later on) of the system. The time state informs on the validity of the element within an OC or of the OC dynamic structure.
an interest level: the interest level is a quantity of the numerical (or even alphabetical) type. It informs on the interest shown in the ES by the person responsible for the OC dynamic structure which possesses it.
an intensity: the intensity is a quantity of the numerical (or even alphabetical) type. It informs on the relevance of the ES in at least one OC dynamic structure for a user responsible for this structure.

(the values of these attributes may be different for the various occurrences of the ES in the dynamic structures)
other attributes, typically for access or presentation, and notably:
   a corresponding language: The corresponding language is a variable indicating the type of language (French, English, etc.) to which the ES refers.
   an access level: The access level defines rights depending on their community, of their universe, and their role (see these notions later on), which the users have for handling (creating, changing, deleting, . . . ) the ES with regard to a EPI.
   a scale: The scale is a quantity of the numerical (or even alphabetical) type such as <(microscale>>, <<macroscale>>, etc. The ESes at a <<microscale>> appear to the eyes of the user if and only if ESes at a larger scale than the <<microscale>> are handled by the user (see also later on, concerning the definition of <<groups>>).

These eigen characteristics are given as an example and form a set of data and parameters which allow application of the method according to the invention.

The eigen characteristics may change over time. The ESes may be characterized by additional parameters such as types (for example an <<operational type>> or an <<administrative type>> in a human resource management application).

An ES is an element which is irreducible in terms of meaning, i.e., it cannot be written as an intersection of at least two ESes.

Group:

A group is of the same nature as an ES and is also defined by a set of eigen characteristics. However it has the additional property of grouping other ESes, in a non-significative order.

A group is characterized by a global mass (MG) which is typically a numerical value. This MG is specific to the group and corresponds to the sum of the relative masses MR of the ESes which form it, added to its own relative mass.

Each of the groups is orthogonal to another group, i.e., it does not cover the meaning of the ESes which make up other groups.

The groups are defined by an access level similar to the ES access level. The groups may have different scales. The scale is a numerical (or even alphabetical) quantity of the <<microscale>>, <<macroscale>> type, etc. The groups at a <<microscale>> may be handled by a user if and only if groups at a larger scale than the <<microscale>> are already handled by the user. Consequently, only the groups which have a scale larger or equal to the one at which the user is working or those which have a scale slightly less than the relevant scale are visible and accessible to the user of the system. Like the ESes, the groups may be characterized by additional types such as <<operational type>> or <<administrative type>>.

Dimension:

A dimension is defined by a set of eigen characteristics. A dimension is a set of ESes and isolated ES groups. Each dimension is not superimposed onto another one, i.e., the sets of groups do not have information and meanings common to each other.

The dimensions are defined by an access level similar to the ES access level. The dimensions may have different scales. The scale is a numerical (or even alphabetical) quantity of the <<microscale>>, <<macroscale>> type, etc. The dimensions at the <<microscale>> may be handled by a user if and only if the dimensions at a larger scale than the microscale are already handled by the user. Consequently, only dimensions which have a scale larger or equal to that at which the users are working or those which have a scale slightly less than the relevant scale are visible and accessible to the user of the system. The dimensions may be characterized by additional types such as <<operational type>> or <<administrative type>>.

Base:

A base is an organized set (in the case in point, a tree set) of ESes, groups and dimensions. For a given ES set, several bases may be produced.

Dictionary:

The dictionary is a set consisting of ESes, groups and dimensions, forming together at least one base. New ESes, new groups and new dimensions may be added and characterized continuously.

The ESes are represented in a global organization scheme using the groups and dimensions so that the ESes are positioned relatively to each other in each base of the dictionary.

Thus, several bases may coexist in a same dictionary so that a user, according to the universe in which he/she is found, (see later on), sees an appropriate base when he/she is seeking ESes capable of characterizing an EPI which concerns him/her.

Universe:

A universe is an entity representative of a interpretation level of the information. For example, for an application in the corporate world, there are many universes such as the universe of research and development, the universe of marketing and the universe of human resources. A universe may also be a type of job in certain cases. According to the universe in which a user is found, the system will allow him to apprehend the set of ESes (and groups and dimensions) of a dictionary according to one of the bases, designated by information in memory identifying the relevant universe. Several universes form together an interpretation spectrum.

Community:

A community means a set of information-bearing entities of the <<person>> type belonging to a same universe.

It will be noted here that in the system, there is a table of persons which indicates, besides various information of an administrative or other nature, the universes and the communities to which these persons belong as users of the system.

Density:

The density of an ES in a population of ESes is the ratio between a number of occurrences of the ES in this population relatively to the total number of ESes of the population. The use of this notion in dynamic structures associated with EPIs will be seen later on.

Concentration:

The concentration of an ES in a population of ESes is a notion analogous to density, but with consideration of the relative masses of the various occurrences of the ES and the relative masses of the other ESes (weighting).

Both pieces of information above may be seen as other attributes of an ES, considered in a given population.

Knowledge Object:

A knowledge object or OC consists of an assembly of ESes from a given dictionary. Each OC has eigen characteristics which may be of two main types:
derived eigen characteristics (typically by calculation or combinational logic) of eigen characteristics of ESes which form the OC,
independent eigen characteristics.

An OC may be simple or complex according to the nature of the assembly. It may contain several ESes from a same dimension or from a same group. The number and the nature of the ESes which form an OC may be changed by authorized users, as this will be seen later on. The meaning of the information is therefore dynamic.

Each ES which forms an OC is characterized by its charge in this OC. The charge here is a numerical quantity of the integer type. With it, it is possible to define the significance of an ES in an OC. (Here, this is another attribute of an ES in an OC).

It is also possible to give a rank to each ES in the OC. With this, the ESes may be considered according to a concatenation, and the OC then becomes an ordered sequence of ESes.

Each ES which forms an OC is further characterized by an NIR, an NRR, a space-time state (see the corresponding definitions above).

The OC itself has also a relative mass MR (see above as regards ESes), established by a computing function of the system which assumes as a parameter the relative masses NR of the ESes which form the OC.

An OC is moreover characterized by a multiplicity order which is a numerical (or even alphabetical) quantity. This multiplicity order corresponds to the number of ESes which make it up. An OC may itself consist of OCs of a lower multiplicity order.

Dynamic Structure of Knowledge Objects:

An OC dynamic structure consists of a single OC or of a set of OCs. Each OC dynamic structure has eigen characteristics other than the eigen characteristics of the OCs which make it up and other than those of the ESes which make up the OCs or even those derived from the latter (independent or derived characteristics, as for the OCs themselves).

In an OC dynamic structure, each OC is characterized by a level. This level is a numerical (or even alphabetical) quantity and indicates the significance of the information represented as an OC in the relevant OC dynamic structure.

In an OC dynamic structure, each OC has interaction links with other OCs of the OC dynamic structure:
each OC first has a coupling capacity. The coupling capacity is a numerical quantity (a positive integer typically) the value of which corresponds to the number of interaction links which the OC has with other OCs;
each OC further has a weight. The weight of an OC is a numerical quantity corresponding to the relative mass MR of the OC multiplied by the coupling capacity.

Each OC further has interaction links with other EPIs of different natures such as for example documents, persons, and business units within an organization such as a company.

In an OC dynamic structure, an OC may further be characterized by an activity state variable: either active or inactive, and a time state variable of the <<valid>> or <<invalid>> type.

All this information makes up as many eigen characteristics or attributes of the OCs.

Moreover the system stores, in association with each OC, characteristic information concerning its position or its change, i.e., information concerning ES variations (addition, removal, replacement or change of an ES) accompanied by time data related to these variations (dates of occurrence of the ESes, dates of change, etc.).

Each OC dynamic structure characterizes an EPI. A same OC dynamic structure may however characterize several EPIs.

As seen above in the glossary, each ES is characterized by its intensity within the OC dynamic structure. If certain ESes are more and more frequently combined in OCs, a function which returns the intensity of this ES within this OC dynamic structure may be established, the value of which will express this growth. For example, this function may be based on algorithms for iterative counting of ES groups in the different OC dynamic structures. Here, this is a dynamic attribute of the ES in a dynamic structure, calculated by the system.

Each ES is further characterized by its level of interest within the OC dynamic structure. This level is established by a function of the system which assumes as a parameter, the interest that the person in charge of the OC dynamic structure indicated upon creating or modifying the ES within an OC as well as the state variables of this OC in the OC dynamic structure.

As knowledge objects are dynamic, the OC dynamic structure changes over time and is adapted to the development of the meaning of the information or of the perception which the users have of it, of the contents of the ES dictionary, etc.

EPI (Information-Bearing Entity):

All the EPIs have characteristics specific to their type. These eigen characteristics are generally objective data as regards the EPI.

From the ES dictionary, the method and system of the invention allow an EPI to be characterized by OCs and OC dynamic structures. Thus an EPI is characterized by at least one OC dynamic structure.

The EPIs may be of very different types. For example, these may be objects of the <<document>> type based on text, image, video and audio entities, optionally combined in order to form multimedia objects.

In the applications of the present invention to the corporate field, the EPIs may also be very different components of a company, and in particular:
persons: client, partner, employee, acquaintance,
documents or other informative contents, as mentioned above,
processes, tasks, activities, missions, etc.
projects,
events,
training courses,
etc.
   Vision:

A vision is a set of ESes, OCs or OC dynamic structures, associated with at least one defined operation, such as a mathematical operation, to be performed on the latter.

### 2) Functional Description

The embodiment of the invention, given as an example below, relates to a processing information method for managing skills and knowledge in a professional environment.

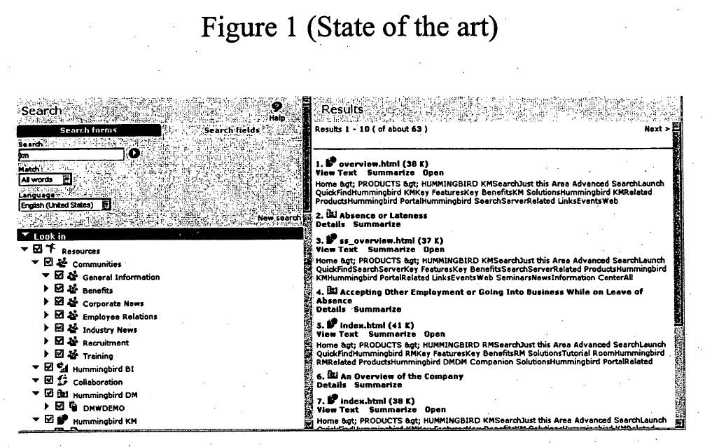

FIG. 1 for example shows the processing information Humminbird™ system for managing contents and managing documents. When a document is entered into the system, it is categorized and indexed in the database so that it may be retrieved. Next, it may be retrieved with a searching system. The first way to retrieve it consists of browsing through the tree structure. The second way consists of using a search engine operating according to the so-called <<full text>> principles, in Anglo-Saxon terminology, semantic and metadata principles to possibly cross the branches of the tree structure and to select the best documents corresponding to the search. This system is an example of the state of the art. It operates by indexing and categorizing the documents.

Unlike the state of the art, the principle of the present invention does not consist in entering documents (or other EPIs) into repositories, indexes, definitions, categories and rules, but conversely, consists of entering determined ESes from repositories, indexes, definitions, categories and rules, into each document or other EPI. These ESes are combined together in order to form ES OCs in order to create OC dynamic structures representative of EPIs.

In order to facilitate the initial implementation of the invention, it may be based on existing systems, by breaking down the repositories, indexes, definitions, categories and rules of these systems into ESes so as to form an initial ES dictionary used in the present invention.

The setting up of the information processing method and system described by the invention thus includes two initial steps.

a) The first step consists of creating the global set of ESes which will form the dictionaries and their bases in a starting version, preferably by recovering and breaking down the static repositories of the existing processing systems, as indicated above. Thus, a dictionary base may be elaborated from at least one breakdown of the present repositories into ESes.

It will be noted here that, starting with a given existing repository system, several different bases of ESes may result. These different bases form different representations of the dictionary.

At the same time, and always for setting up the system, all the communities may be induced to giving the list of the ESes which they use or wish to use.

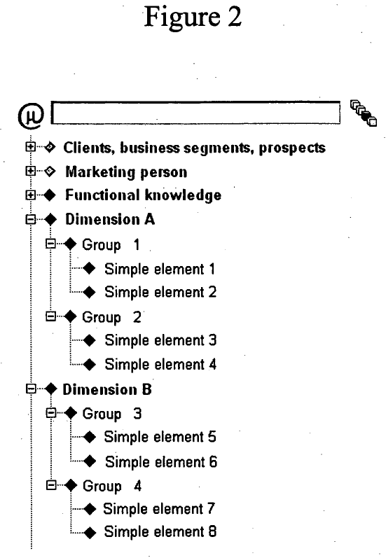

FIG. 2 shows an ES dictionary example in a preferred embodiment. In this example, at least one community of an organization has defined a portion of its dictionary from a repository of skills established by the community of experts from the human resource universe. The repository is broken down into ESes by professionals belonging to other universes. The dictionary is shown here as a hierarchical tree with a user interface analogous to that of the document explorer of Microsoft's Windows™ environment. Computer memory containing these elements is structured accordingly in a way perfectly accessible to the skills practitioner.

In this dictionary, groups (designated here by <<Group N>>) are formed from unions of ESes (designated here by <<Simple N element>>) with a global meaning. Once the groups are formed, dimensions (here <<Dimension A>>, <<Dimension B>>) are built from unions of groups. There may be a significant number of ESes, groups and dimensions. This number increases as the information system develops over time (and as ESes are added by certain authorized users) and extends to all the universes of the organization and to all the EPIs.

At least one community responsible for administrating all or part of the dictionary has the capability of defining certain eigen characteristics (notably attributes) of ESes, groups and dimensions, the management of which is their responsibility. As regards the ESes, they may define the names, symbols, descriptions, MRs, relationships with certain other ESes, PSARs, corresponding language, access level and scales.

For example, it is possible to define in the computer memory of the dictionary, an ES which reflects a quality or skill, i.e., a <<communicating capacity>> skill. Its name is <<communicating capacity>>, its symbol is also <<communicating capacity>> in the present case. Its description contains human quality type information (<<qualities>>) such as for example <<1) Promoting dialog, 2) Adjusting one's communication and relationships—adapt to context and to persons talking>>. In the present case, the information is used for indicating how to evaluate the NIR and NRR of the ES independently of the OCs in which this ES will be placed subsequently. In other cases, the information may be used for indicating the meaning of the ES in a detailed way. In the present case, the MR is 2, i.e., the total number of qualities in the ES. The relationships of the ES with other ESes may be apprehended by a graphical location of the ES in the dictionary, relatively to the other ESes. The <<communicating capacity>> ES is related to the <<developer>> ES through a relationship <<should be associated with>>. The PSAR is of <<level 2>>. The access level is defined at its maximum here, i.e., free access for all the users regardless of their universe. The scale is set to the <<macroscale>> level, which, as indicated, determines the way how the ES will be displayed during the browsing of the user through a base.

The characteristics such as the pointer, PSOR, NIR and NRR, space-time state, interest level, the intensity are defined when the system is operational, i.e., when OCs and OC dynamic structures are created or changed. The value of the pointer can only be found out by a specially authorized user (a super-administrator) of the system.

For each ES, group and dimension, an <<operational>> or <<administrative>> type (anyhow in the present application) may be defined as well as an access level and a scale as stated.

Once the ESes, groups, dimensions and eigen characteristics specific to each one of them, are established, stored and accessible to the users through a suitable user interface, the dictionary is generated and ready to be used. The latter changes whenever an operation, as for example an addition or change, is performed on the ESes, groups, dimensions and their eigen characteristics by at least one administrator (or other authorized person) of the system.

b) The second step consists of building, on the basis of the generated dictionary, for all the EPIs making up the information system, the OC dynamic structures and the OCs which characterize them. For this, each person responsible for a set of EPIs will create for each EPI, dynamic structures based on OCs grouping ESes from the dictionary. For each OC, a set of eigen characteristics is defined by the relevant responsible person and stored.

On the computer technique level, all the information representing the OC dynamic structures and their contents is stored in at least one database, whereas an associated database manager includes the algorithms required for dynamically tracking these structures. Alternatively, it is possible to resort to structures of the XML file type in association with Java type environments or the like.

This database saves characteristic information in memory which concerns the state and the change of the dynamic structures, and notably the time-stamped ES variations (additions, suppressions, replacements, and changes of the ESes or at least certain eigen characteristics of the ESes or OCs).

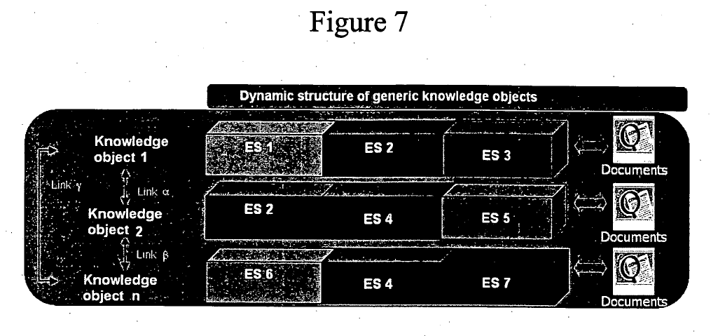

FIG. 7 illustrates a generic OC dynamic structure used by the method according to the invention. Here n OCs have been illustrated, named <<knowledge object N>>. The <<knowledge object 1>> OC consists of three ESes named ES1, ES2, and ES3. The <<knowledge object 2>> OC consists of three ESes, i.e., ES2, ES4 and ES5. The <<knowledge object 3>> OC consists of three ESes, i.e., ES6, ES4 and ES7. Preferably, the OC structure appears in the memory of the computer system as a table including the identifiers or pointers of the OCs as well as the identifiers or pointers of the ESes forming the respective OCs. Thus, the system has first information characterizing the presence of ESes in the OCs of a dynamic structure and second information characterizing the fact that ESes are grouped with other ESes in a same OC. The memory further contains various eigen characteristics (see the definitions above), notably attributes which will have been assigned to the ESes or OCs, either manually or by computation.

It is already observed that a same ES (ES2 or ES4 here) may be found twice or several times in the structure, with a density and a concentration (see above) which will increase consequently. As it is also seen, certain attributes of this same ES may have different values for the different occurrences of this ES in the structure.

Additionally, FIG. 7 shows that each OC may be linked with any other OC of the same dynamic structure, for purposes detailed later on. These links may be found in a link table stored in the computer system. It will be noted here that an OC may contain other OCs, themselves further containing either other OCs or ESes, or both.

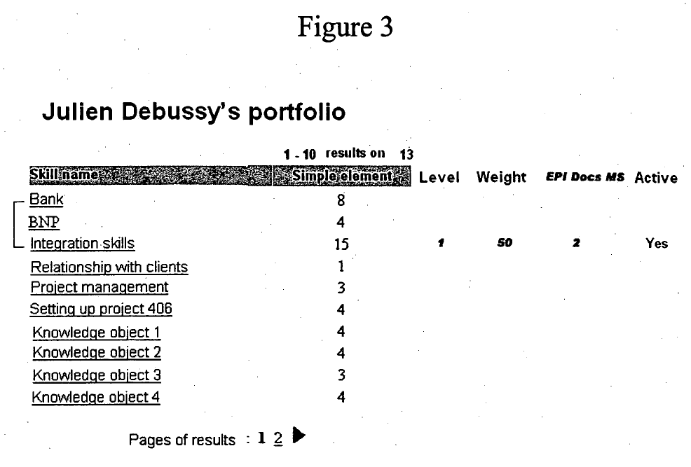

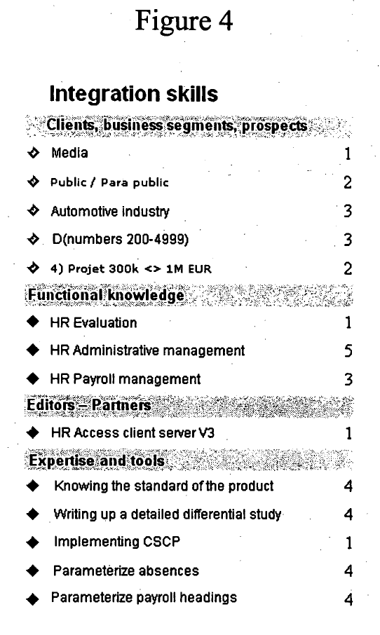

Thus, the present invention codes the information in a discontinuous way in OCs, each OC having a multiplicity order equal to the total number of ESes which it contains. For example, in FIG. 3, the <<integration skills)>° OC has a multiplicity order of 15. As for FIG. 4, it shows the detail of an <<integration skills” OC for which the multiplicity order is equal to 14, this OC encompassing four knowledge sub-objects SOC with multiplicity orders equal to 5, 3, 1 and 5, respectively.

Advantageously, the system of the invention provides the user with editing tools (<<drag-drop>> ES function from a window showing at least a portion of the contents of the ES dictionary, ES or OC selecting, duplicating, cutting, copying, pasting functions, etc.) for facilitating his/her work of designing an OC dynamical structure.

Each ES involved in the composition of an OC is also evaluated by the person responsible for the OC (typically an immediate supervisor in a human resource management application) by giving specific values to the different attributes of the ES which the person is authorized to set (notably the relative imaginary level NIR, with a value between 1 and 5—a scale which may be parameterized upon setting up the system—, as illustrated in the right column of FIG. 4).

Other values of attributes such as <<charge>) and <<rank>> (not illustrated in FIG. 4) are also set by the responsible person.

Additionally, each ES involved in the composition of this OC is evaluated by at least one other person, in order to give a value to the NRR attribute of this ES (notably when an immediate supervisor will <<note>> the skills which one of his/her subordinates has declared in the OC dynamical structure supposed to characterize the relevant subordinate (an EPI of the skill portfolio type) in the system.

More specifically, the ESes and the OCs are first of all evaluated by a person who has created them initially. This first evaluation corresponds to the NIR. Subsequently, other persons may be in charge for evaluating these ECes and these OCs, but the NRR is preferentially determined only for the ESes which are valid or active. Thus, as soon as an ES or an OC passes from a non-validated state to a validated state, or from an inactive state to an active state, the NRR is calculated by a function for evaluating the NRR implemented by the computer system, which takes into account the evaluations of the ES and of the OC performed by other persons authorized to do so.

Advantageously, the NRR calculation applies weighting according to the respective weights of the other persons which have performed the evaluation.

Subsequently, all other calculations of the system which take into account the values of the NRR attributes of the ESes or OCs are performed.

Finally, independently of the users, the multiplicity orders, the NRs, etc., are determined by suitable calculations performed by the system.

These operations are typically repeated whenever a dynamical structure is created or changed by an authorized person, or even according to the load of the computer system applying the method, at determined batch processing dates (daily, etc.).

Referring back to FIG. 3, the latter represents the list of ten OCs (all of the <<skill>> type) of a dynamical structure of the <<skill portfolio>> type of a particular EPI of the corporate person type. It is seen that the OC designated as <<integration skills>> already considered above is characterized by a level of <<1>> which means here that the individual does not very much appreciate applying this skill. This OC is linked with the OC designated as <<bank>> which shows that the <<integration skills>> OC represents a concept close to the concept represented by the <<bank>> OC The coupling value is <<1>> because the OC has a single interaction link. If the <<integration skills>> OC was also for example linked to the <<Knowledge object 1>> OC, then the coupling value would become <<2>>. The weighting value of the <<integration skills>> OC is <<50>>. This value is calculated here by adding the masses of the 15 ESes which make up the OC and by multiplying this sum with the coupling value, in this case <<1>>. The <<integration skills>> OC has interactions (links) with two EPIs which in this case are two documents representing simulation of the skills (EPI Docs MS in FIG. 3). The <<integration skills>> OC is declared as <<active>> in the OC dynamical structure, which means that the individual has decided to apply this skill in the future and that he/she wishes that this be taken into account by the information processing system. With the <<active>> activity state variable the result of all the functions of the system which take into account the active or inactive state of an OC, may be changed. For example, a <<skin portfolio>> type EPi may contain in its dynamical structure <<latent>> skills, which the person does not wish to put forward in his/her professional environment. In this case, the OC grouping the simple elements representing these skills in the dynamical structure is set to <<inactive>>, to such an extent that the functions for searching for a candidate with these skills in particular for a given position, will ignore the relevant OC. But, as soon as the OC is activated, the searches for profiles will take it into account. Therefore this is an attribute which may be very important in a human resource management application. An <<active>> or <<inactive>> state may also be provided at the level of the individual ESes.

As seen earlier, upon creating the OC, the creator may give values to the NIR attributes of each of the ESes which make up the OC. FIG. 4 thus shows for example that the <<HR—Evaluation>> ES in the <<integration skills>> OC is appreciated with an NIR of <<1>>, which may indicate a beginner level in the context of the 15 ESes. As an option for the system administrator, there may be one NIR per ES or one NIR per ES and per OC in an OC dynamical structure.

The system is capable of dynamically performing many other calculations based on information contained in the OC dynamical structures, and for example in connection with attributes of intensity, interest level, knowledge conversion rates of the person responsible for the EPI, etc.

It will be noted here that it is not necessary to describe these calculations in detail, a great number of approaches may be exist when the matter is to combine together individual values (averages, weighted averages, sums, products, minima, maxima, etc., as well as all their combinations).

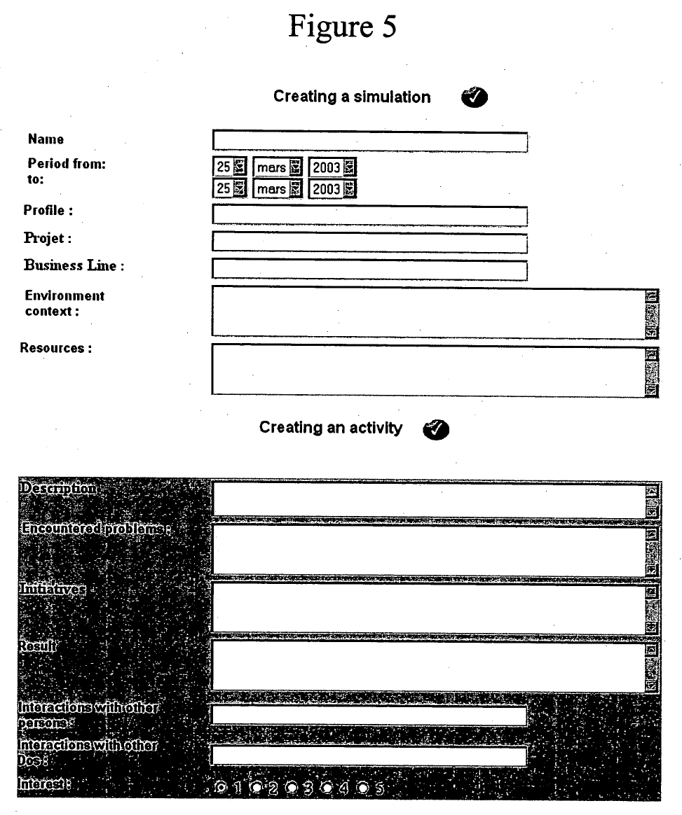

FIG. 5 illustrates a standard display for creating an EPI of the <<simulation>> type. A system administrator may create new simulation formats. Advantageously, there are several simulation formats accessible from a document library.

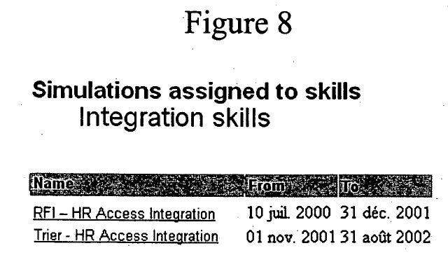

FIG. 8 illustrates the representation on a screen of the system, of a list of two documents, which are documents of the <<simulation>> type, associated with the <<integration skills>> OC. In these documents, information is also found concerning the persons whom the individual has estimated as being useful for developing his/her skills, the persons who have contributed to achieving a goal and what the individuals have learnt from a project. It was seen earlier that characteristics specific to the OC may be associated with each OC. Such characteristics may be associations or links with documents.

According to an embodiment of the invention where an EPI is the dynamic portfolio of the skills of an individual, each skill is modeled by an OC of variable size which may be linked to other OCs. The dynamic portfolio of skills is thereby represented by the OC dynamical structure established by at least one immediate supervisor.

Each skill of the individual is intended to be associated with at least one simulation of the skill, consisting of a document. The information provided by the user upon filling out this document may be transferred towards the database which manages the OC dynamic structure, towards an XML document or any other type of data file. With the method, it is thereby possible to find out, during a simulation, a certain number of attributes (for example the <<interest>> attribute) or other eigen characteristics of the ESes of an OC, or of the actual OC.

As the OCs are dynamic, the OC dynamic structure changes over time and adapts to the development of the EPI. More generally, the OC dynamic structures are integrated into the EPIs and are independent of the communities of experts.

By interacting with the system, each person responsible for his/her EPIs will give a meaning to each piece of information. The OC dynamic structure of an EPI is then created as the OCs are established, changed, characterized and coupled with other ones. Finally, all the EPIs managed by the information processing system will be characterized by more and more complex OC dynamic structures, closer to the actual and updated information, contained in the EPI.

The EPIs may notably be:
objects based on informative entities of the text, image, video and audio types or their combination (multimedia objects),
the different components of an organization such as a company (client, partner, employee, acquaintance, documents, informative contents),
different properties of a person (for example a <<skill portfolio>> object), a process, a document, a task, an activity, a mission, an event, a project, a training course,
and more generally any objects for which a definition in terms of an OC dynamic structure in the sense of the present invention is suitable.

According to the EPI types, the eigen characteristics may be different. For example:
for an EPI of the dynamic portfolio type, the eigen characteristics are relative to the individual having these skills. These eigen characteristics are described for example in the civil status of the individual as well as all the data known about the individual such as his/her photograph, salary, experience, training, CV, role in the organization, position/job, current project, identity of his/her boss within the organization, documents with which he/she interacts, the persons with which the individual has good relationships, his/her preferences, etc.
for an EPI of the document type, the eigen characteristics are for example its title, its author, the place where the document is physically located, its creation and/or modification dates, the type of document, it target audience, its language, its comments, its links, the documents or the persons referring to it, its communities of interest, the questions to which the document provides the best answers, its summary, etc.

The system is operational when all the targeted environment is represented as OC dynamic structures.

A certain number of advantages brought by the present invention will now be described.

First of all, the invention is simple to make, light and quick to implement as it is sufficient to list and characterize the ESes and organize them in dimensions, groups, bases, and dictionary. It is no longer necessary to build repositories, indexes, definitions, categories and rules. It is no longer necessary that all the communities reach an agreement about this. Indeed, the users authorized to build OC dynamic structures are not constrained by the structure of the dictionary. The complexity, the unwieldiness and the implementation time are reduced very significantly.

The information processing system is dynamic and continuous. To add and change ESes in the dictionary, it is sufficient to do it without having to interrupt the system. It is no longer necessary to reconsider the repositories, indexes, definitions, categories and rules, it is sufficient to add ESes in the dictionary as soon as an authorized user makes a request for this and that this request is acceptable. The richness of the informational organization is no longer in the repositories, indexes, definitions, categories and rules but in the way how to combine ESes in order to form OCs and OC dynamic structure of each EPI. The development of the meaning of the information is given by the development of the contents of the OC dynamic structures.

Additionally, the system is open. The communities which have access to the information processing system use the same dictionary. However, the persons from these communities create OCs and OC dynamic structures according to construction schemes which are specific to them. With the invention, the persons do not handle EPIs through repositories, indexes, definitions, categories and rules specific to their universe but handle EPIs through OCs and different OC dynamic structures according to their universes. The system is independent of the observer. According to his/her level of interpretation of information, this observer handles OC dynamic structures with higher or less complexity and of different natures. The system remains invariant relatively to the addition of communities, universes and EPIs.

The system is distributed and operational. The system operates on an interactive and collaborative mode. All the persons add value to the information contained in the EPIs. Each person knows how to use the system according to his/her level of interpretation of information. From now on, the larger the number of persons using the system daily, the more performing and qualitative becomes the system.

The system is further expandable. Adding a new EPI does not pose any problem as the system does not directly use EPIs but their dynamic structures. Upon adding new EPIs, it is sufficient to create OCs and OC dynamic structures in order to be able to handle these new EPIs and to perform operations between EPIs by including them.

Moreover, with the invention, information may be contextualized (for example the <<context>> of a piece of information represented by two ESes contained in an OC with five ESes being defined by the three complementary ESes within the OC). Thus, when the method searches for an EPI having such and such ES, it may do this by taking into account the direct or indirect neighbourhood of this ES.

The OC dynamic structures have the dual advantage of having an indifferent size, and of being able to vary more or less substantially. Thus, the OCs may be quickly subject to sudden transformations, and the variation level of the OCs of a dynamic structure or of the whole of the structure may also describe the corresponding EPI: in certain applications, an EPI with a structure which varies often and/or substantially, may be considered as more interesting than other ones on the informational level.

### 3) Other Embodiments

Other embodiments may for example be described for managing knowledge, contents, processes, training courses, customers, suppliers, partners, organizations, tasks, activities, missions, events, projects, text, image, video, audio, multimedia entities, and more generally management of any object for which it might be interesting to have it defined as an OC dynamic structure, as described in the foregoing.

### 4) Handling Engine

In association with this new description of EPIs by OC dynamic structures, the invention allows these structures to be handled so that their potential can be fully used, and while further getting rid of unwieldiness related to repositories, indexes, definitions, categories and rules, it being specified that there exist an infinity of achievable handling operations.

In a preferred embodiment, the present invention includes software code, called a handling engine, with which handling operations to be carried out, stemming from one or several basic functionalities (as numerous and varied as desired) provided by the engine, may be defined or parameterized at the level of an authorized user or even of an administrator, and they may themselves be combinations of simple operations (arithmetic, Boolean operations, etc.). Once a handling operation has been defined, the handling engine executes it and generates the result.

The functionalities and the handling operations are created according to the needs of each person interacting with the system. The persons may themselves create handling operations to be carried out on OC dynamic structures and by building them themselves, by combining basic functionalities, i.e., by combining different criteria (sorting operations, filters, various tests, etc.) to be applied to the ESes, OCs, and OC dynamic structures.

Thus, by means of these customized handling operations, each user may create his/her own vision of the system.

Additionally, it is possible for example to measure the similarity between two EPIs of completely different natures (for example an object of the person type and an object of the document type) by studying the correlation of their OC dynamic structures. The similarities do not depend any longer on repositories, indexes, definitions, categories and rules but on relationships between OC dynamic structures. More particularly, functionalities, such as comparisons between job profiles and individual profiles, between individual profiles, between individual profiles and between EPIs more generally, which hitherto did not give very significant results, now provide more qualitative results closer to reality.

The processing strategy used by the handling engine is specific to each functionality and the algorithms to be applied are selected as those which best correspond to the desired use in a given application.

With the system, it is possible to process operations according to two modes: a synchronous (real time or quasi-real time) mode and an asynchronous (off-line) mode. According to the synchronous mode, calculations are performed when the functionality is invoked. According to the asynchronous mode, the calculations may be performed when the power required for the functionality is available from the system.

For each created functionality, the user may apply constraints and filters, so as to only take into account in the handling operations, ESes, OCs, and OC dynamic structures which are qualified for this functionality, this in order to return a result of better quality as compared with the object of the functionality and to avoid unnecessary processing operations.

In addition, the setting up of the new data modeling of the invention based on OC dynamic structures opens the path for new functionalities and new steps.

Thus, with certain functionalities, the behavior of an OC dynamic structure may be investigated and viewed.

In this respect, it is seen that an OC dynamic structure changes over time. At its creation it changes a lot, but generally it stabilizes. With the invention, the different development phases of an OC dynamic structure may be investigated in order to better understand the corresponding EPI. When an EPI has a dynamic structure which is stabilized, it becomes interesting to investigate the behavior of this dynamic structure over time depending on the environment in which the OC dynamic structure develops.

Thus, by studying the behavior of an OC dynamic structure, we are informed on the energy and inertia level of the EPI as well as on the environment in which the OC dynamical structure develops. The energy variations are calculated from the OCs and from changes which are involved in the OC dynamic structure.

Other functionalities allow the density, the ES concentration, etc., to be measured in an OC dynamic structure or in a group of OC dynamic structures.

Other functionalities further allow the information acquisition rate possessed by an EPI, to be measured as well as the power (variation of the energy during a period of time) of an OC dynamic structure and a group of OC dynamic structures.

Other functionalities allow the relevance of the gathered information to be measured in an OC dynamic structure with respect to a request.

Other functionalities allow the average educational level of the persons responsible for EPIs to be measured for example by calculating the average NRR over the set of the ESes of the selected OC dynamic structure, the frequency of use of the OC dynamic structures, the information refreshing dates, etc.

Other functionalities allow the skill potential of an organization to be measured as well as the skill potential of each individual or group of individuals by combining all the criteria retained in the system.

Other functionalities allow determination of an <<action potential>> of an EPI, by measuring the number of active OCs, the number of inactive OCs, and their distributions.

Other functionalities are able to inform the user on the distribution of the ESes, the information fluxes within the EPIs and between EPIs, the organization level, the impact of changes, the consistence between the EPIs, etc.

More generally, with the present invention, it is possible to investigate the emergence of order at a collective level, the behaviour of individuals or groups of individuals depending on the environment, etc.

With it, it is also possible to characterize the environment in which a group of individuals move. Thus, in a highly educated environment, instability may develop under the effect of competition between two processes:
a facilitative process: knowledge tends to favor growth of knowledge in one's neighborhood and the environment is favorable to acquisition of knowledge and its sharing;
a competitive effect: to distinguish themselves, to retain their power in an organization, an individual or a group of individuals will attempt to keep their knowledge for themselves and not make the community benefit from them.

Other functionalities allow the PSOR and the interest of each ES to be calculated and more generally all sorts of calculations on attributes to be carried out.

It is understood that in a human resource and skill management application, a system of the invention allows the implementation of numerous functionalities relating to the significance, the hierarchization, the redundancy, etc., between skills.

As a conclusion, with the invention, in particular it is possible to transform all the complex, unwieldy, static and discrete, close, centralized and administrative and finite information systems which are long to implement, into simple, light, dynamic and continuous, open, distributed and operational and expandable systems, which are rapidly implemented.

Thus, the invention thereby provides a solution to the problems related to the classification of large volumes of heterogeneous information. With the invention, it is possible to simplify, alleviate and accelerate the implementation of a qualitative and expandable information processing system, which may be used by different and various communities of persons having different levels of interpretation of information. With the invention, it is possible to take into account the fast and continuous development of the meaning and significance of the information. The quality of the information processing system may be levelled from the top by the invention. With the invention, the system may develop continuously and adapt to diversity and to the high increasing numbers of managed EPIs. Finally, the information provides contextualization of information contained in the EPIs.

The foregoing description was given for illustrative and descriptive purposes. The object of these purposes is not to be exhaustive or to limit the invention to these specific embodiments but it should be understood that many modifications, variations are possible in the light of these teachings. The embodiment, as well as the practical application to management of skills and knowledge, were selected and described in order to clearly explain the principles of the invention and its practical applications and to allow the skin practitioner to adapt it to the intended use.

1.-16. (canceled)

17. A method of processing information, comprising:
(a) storing in a memory of an information processing system:
(i) a plurality of individually identified information-bearing entities (“IBEs”), and
(ii) a dictionary including a plurality of irreducible simple elements, each simple element having a meaning;
(b) storing a plurality of dynamic structures in the memory, each dynamic structure being stored in association with at least one stored IBE, the dynamic structure including (i) at least one knowledge object, the knowledge object including a plurality of simple elements selected from the stored dictionary, (ii) first information identifying the selected simple elements in the at least one knowledge object and (ii) second information identifying links between the selected simple elements; and
(c) processing ones of the stored IBEs with a processor of an information processing system using the first and second information contained in the stored dynamic structures associated with the ones of the IBEs.

18. The method as claimed in claim 17, wherein a number of knowledge objects and a number of simple elements included in each of the plurality of dynamic structures are subject to vary.

19. The method as claimed in claim 17, wherein the plurality of knowledge objects and plurality of simple elements included in the plurality of dynamic structures are subject to vary with time.

20. The method as claimed in claim 17, wherein the selection of simple elements identified by the first information and the links between the simple elements identified by the second information of each of the plurality of each dynamic structures are subject to vary with time.

21. The method as claimed in claim 20, wherein the selection of simple elements and the links between the simple elements are subject to vary with time in accordance with the processing the ones of the IBEs, the processing being performed under control of a user of the information processing system.

22. The method as claimed in claim 17, wherein a first simple element of the plurality of simple elements is included in each of at least some dynamic structures of the plurality of dynamic structures.

23. The method as claimed in claim 17, wherein a knowledge object of each stored dynamic structure includes at least one attribute of a simple element included in the knowledge object, and the processing is performed using at least some attributes of the simple elements included in the ones of the plurality of dynamic structures.

24. The method as claimed in claim 23, wherein attributes of the simple elements included in the plurality of dynamic structures have values, each value being selected from the group consisting of: (i) values set by a user of the information processing system, (ii) values calculated according to other information included in the dynamic structures which contain each simple element, and values calculated according to the number of occurrences of each simple element in all or a determined part of the dynamic structures which contain each simple element.

25. The method as claimed in claim 24, wherein each stored dynamic structure further includes at least one knowledge object attribute associated with each knowledge object, wherein the processing step is performed using at least some attributes of the knowledge objects included in the plurality of dynamic structures.

26. The method as claimed in claim 25, wherein a value of the at least one knowledge object attribute is calculated from values of attributes of the simple elements contained in a particular knowledge object.

27. The method as claimed in claim 25, wherein the step of storing the plurality of dynamic structures includes setting a value of at least one knowledge object attribute by an operator.

28. The method as claimed in claim 27, wherein the steps (a) and (b) are performed to create starting dynamic structures, the method further comprising performing the steps (a) and (b) under control of an authorized user of the information processing system with respect to the IBEs and the at least one knowledge object in each starting dynamic structure to create modified dynamic structures.

29. The method as claimed in claim 27, further comprising storing at least one base in the memory, the base including a plurality of dimensions, each dimension including at least some of the plurality of simple elements organized into a plurality of groups, the method further comprising using the information processing system to graphically display a layout indicating the organization of the plurality of dimensions and groups included in the base.

30. The method as claimed in claim 29, wherein each group is represented in the memory as a simple element, that simple element representing a group being selectable in knowledge objects in the same manner as other simple elements.

31. The method as claimed in claim 29, wherein the stored dictionary includes a plurality of different bases, each of at least some of the plurality of simple elements being organized in at least one of multiple different groups or dimensions, and the displaying step includes displaying one of a plurality of visual organizations, each visual organization corresponding to a layout of one of the plurality of different bases.

32. The method as claimed in claim 31, further comprising:
storing a user table in the memory, the user table including membership attributes of a plurality of users and identifiers associated with the plurality of users; and
in accordance with a value of the membership attribute of the user, displaying a visual organization corresponding to the layout of a base designated by a membership attribute of a user, and, when necessary, displaying only a part of a base designated by the membership attribute of the user.

33. The method according to claim 32, wherein the layout of a base is a tree-structure layout, and the layout of only a part of a base includes a limited number of tree-structure levels.

34. The method as claimed in claim 17, wherein the processing step includes comparing the dynamic structures associated with at least two of the plurality of information-bearing entities.

35. The method as claimed in claim 34, wherein the processing step includes comparing the dynamic structures associated with a plurality of the information-bearing entities with one or more dynamic structures belonging to one or more standard information-bearing entities.

36. The method as claimed in claim 35, wherein the comparing step implements at least one of a mathematical or logical combination of at least one of presence or absence of simple elements in the plurality of dynamic structures, at least one of the presence or absence of simple elements together in knowledge objects of the dynamic structures, and values of attributes of simple elements and knowledge objects.
